(19) United States
(12) Patent Application Publication
(10) Pub. No.: US 2006/0082014 A1
(43) Pub. Date: Apr. 20, 2006

(54) Kit, apparatus and method for reverse imprint casting

(76) Inventor: Bonnie L. Krum, Reno, NV (US)

Correspondence Address: VIRTUAL LEGAL, P.C.;MICHAEL A. KERR, 3476 EXECUTIVE POINTE WAY, UNIT 16, CARSON CITY, NV, 89706, US

(21) Appl. No.: 11/251,612

(22) Filed: Oct. 14, 2005

Related U.S. Application Data
(60) Provisional application No. 60/619,760, filed on Oct. 15, 2004.

(51) Int. Cl. B29C 33/40

(52) U.S. Cl. 264/227; 425/117

(57) ABSTRACT

A reverse imprint casting kit comprising a mold having a geometric shape, an imprint mixture, a powdered molding compound, and a container. The mold comprises a first section and a second section, each having interlocking tabs. The imprint mixture is non-toxic and non-irritating. The container is configured to receive the powdered molding compound and water. The geometric shapes include but are not limited to a circular shape, a quarter-moon shape or a heart shape. The interlocking tabs of the first section and second section of the mold are configured to interface with one another and further configured to be separated when slight pressure is applied.

### CROSS REFERENCE

This patent application is related to provisional patent application 60/619,760 which was filed on Oct. 15, 2004.

### BACKGROUND

1. Field of Invention

The invention is related to a reusable imprint kit, apparatus and method for generating a reverse imprint cast. More particularly, the invention is related to a reusable kit comprising an imprint mold with an interlocking first section and second section forming a geometric shape, a nontoxic, non-irritating imprint mixture, and a molding compound.

2. Description of Related Art

Consumers want to produce replicas of body parts using handicraft kits as mementos. However, kits produced for consumer use are not suitable for use on children or pets because they take too long to receive an impression and require the subject come into contact with irritating and/or toxic materials. Furthermore, existing kits do not allow for the creation of more than one imprint, may create an overly-realistic impression, and are for single use only.

For example, some kits use plaster of paris for making an imprint cast. However, this method is not suitable for children or pets because it requires that the child or pet come into contact with an irritating substance, such as plaster of paris, which can cause burns, for three to five minutes. Additionally, a child or pet does not have the tolerance for remaining still with a body part in direct contact with the irritating substance.

Thermoplastic foam can be used as a fast-setting molding compound. However, thermoplastic foam is not a preferred substance for creating mementos, because the resultant impression is easily alterable, uses a substance which is not cheap or readily available to consumers, is not reusable, and does not create a definite impression, like the fine lines of a handprint.

Gels such as that used in orthopedic bandages can be used as a fast-setting molding compound, but this too is not a preferred substance for creating mementos. This product does not form definite impressions, but rather, is limited to use as a protective and therapeutic layer around an injured person's limb.

Other casting techniques rely on pre-cut molds that do not allow the user to create casts, are not reusable, and require the use of thermoplastic resin pellets, a substance which is not readily available.

When creating a memento, it is desirable for a consumer to create more than one impression using the same mold. Some prior kits allow the user to create a textured two-dimensional cast of a hand set in a plaster frame. However, these processes do not allow the creation of more than one impression, and the gel is not easily obtainable.

### SUMMARY

A reverse imprint casting kit comprising a mold having a geometric shape, an imprint mixture, a powdered molding compound, and a container. The mold comprises a first section and a second section, each having an interlocking tab. The imprint mixture is a non-toxic and non-irritating substance. The container has a re-sealable lid, and is configured to receive the powdered molding compound and water.

The geometric shapes include but are not limited to a circular shape, a quarter-moon shape or a heart shape. The interlocking tabs of the first section and second section of the mold are configured to interface with one another and further configured to be separated when slight pressure is applied. The mold further comprises a level line, configured to be used as a guide to determine the desired depth in which to insert the mold into the imprint mixture. The illustrative molding compound is configured to cure within 24 hours.

An apparatus for producing a reverse imprint cast is also described. The reverse imprint apparatus comprises the geometrically shaped mold with the interlocked first section and second section that are disconnected by depressing tabs. An imprint is generated by pressing an object into the imprint mixture, and the mold is placed into the imprint mixture up to a level line. A powdered molding compound is mixed with water inside a re-sealable container, the molding compound poured into the imprint mixture and mold, and allowed to partially cure. The imprint mixture is removed and the interlocking first section and second sections are released. The molding compound is permitted to completely cure, resulting in the reverse imprint cast.

A method for producing the reverse imprint cast is also described. The method comprises providing the imprint mixture, shaping the imprint mixture to receive a mold, pressing one or more objects into the imprint mixture, placing the mold into the imprint mixture up to a level line, mixing water with a powdered molding compound, and pouring the molding compound into the imprint mixture and the mold, allowing the molding compound to partially cure, removing the mold and the imprint mixture and allowing the molding compound to fully cure, resulting in the reverse imprint cast. The method further comprises providing a flexible material that is bent, inserted into the molding compound and used as a hanger. The method permits a user to repeatedly generate a plurality of reverse imprint casts using the same mold and the same imprint mixture.

### BRIEF DESCRIPTION OF THE DRAWINGS

Embodiments for the following description are shown in the following drawings:

FIG. 1 is a diagram of an illustrative process used to generate a reverse imprint cast.

FIG. 2 is a flowchart of an illustrative process to produce a reverse imprint cast.

FIG. 3 is a top view of an illustrative circular mold with the illustrative imprint cast positioned inside of the mold.

FIG. 4a is a top view of an illustrative imprint cast which is created during imprint casting.

FIG. 4b is a side view of an illustrative imprint cast which is created during imprint casting.

FIG. 5a is an isometric view of a half of an illustrative circular mold.

FIG. 5b is a side view of a half of an illustrative circular mold.

FIG. 5c is a top view of a half of an illustrative circular mold.

FIG. 5d is a front view of a half of an illustrative circular mold.

FIG. 6a is an isometric view of a half of an illustrative heart shaped mold.

FIG. 6b is a front view of a half of an illustrative heart shaped mold.

FIG. 6c is a top view of a half of an illustrative heart shaped mold.

FIG. 6d is a side view of a half of an illustrative heart shaped mold.

FIG. 7a is an isometric view of a half of an illustrative quarter moon mold.

FIG. 7b is a front view of a half of an illustrative quarter moon mold.

FIG. 7c is a top view of a half of an illustrative quarter moon mold.

FIG. 7d is a side view of a half of an illustrative quarter moon mold.

### DESCRIPTION

Persons of ordinary skill in the art will realize that the following description of the present invention is illustrative and not in any way limiting. Other embodiments of the invention will readily suggest themselves to such skilled persons having the benefit of this disclosure. It shall be appreciated by those of ordinary skill in the art that the apparatus described hereinafter may vary as to configuration and as to details. Additionally, the method may vary as to details, order of the actions, or other variations without departing from the inventive concepts disclosed herein.

A reusable reverse imprint kit, apparatus and method is described herein. The reusable kit, apparatus and method can accommodate small children and pets, one or more body parts, and uses materials which are inexpensive, nontoxic and readily obtainable. The kit includes a mold, a formula for generating an imprint mixture, a powdered molding compound, a re-sealable container for mixing the molding compound, and a mold comprising two halves of a geometric shape, further comprising one or more interlocking tabs and a level line.

Generating an imprint cast includes receiving an impression of an object formed in an imprint mixture that is bounded by a mold. Casting is giving a shape to a substance by pouring a liquid or plastic into the mold and/or an impression, and letting the liquid or plastic harden without pressure. The mold is used to shape the liquid or plastic form. A molding compound is a mixture of substances poured into the mold to form the imprint cast. Curing refers to the process wherein a liquid substance, semi-liquid substance, semi-solid substance or any combination thereof is dried into a relatively fixed and rigid form. A substance may be partially cured or completely cured. Partially cured assumes that there is “wetness” to the substance and complete curing assumes that there is little or no wetness associated with the substance.

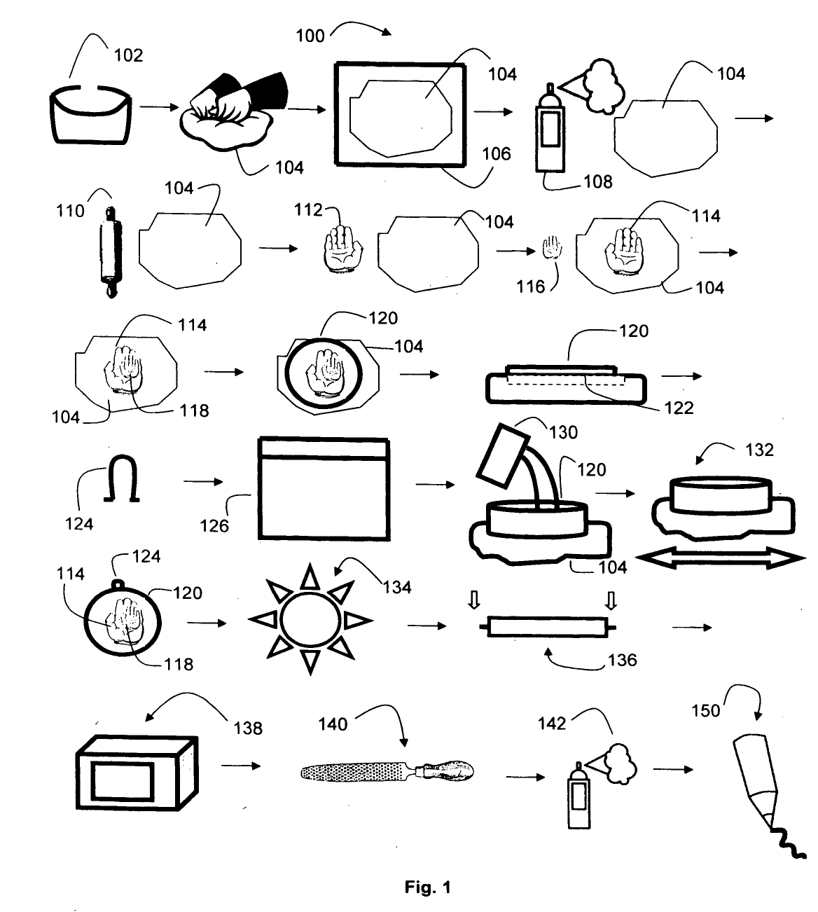

Referring to FIG. 1 there is shown a diagram for generating the reverse imprint cast. The user first generates an imprint mixture 102 using an illustrative formula described below. The imprint mixture 102 is nontoxic and nonirritating. The imprint mixture 102 may be composed of inexpensive common household materials. Two to three pounds of the imprint mixture 102 are generated by first mixing flour, cream of tartar, water, salt and oil until the resultant dough is non-sticky and pliable.

One illustrative imprint mixture formula comprises combining three cups of flour, three quarter cups of salt and six tablespoons cream of tartar in a cooking container that can hold at least four quarts of volume. Three tablespoons of vegetable oil and three cups of water are added to the imprint mixture. The imprint mixture is stirred over medium heat in the cooking container for three to five minutes. After three to five minutes, the imprint mixture forms a ball in the center of the cooking container. The imprint mixture is then removed from the cooking container and placed on a flat surface which is lightly sprinkled with flour.

The illustrative imprint mixture formula is allowed to cool to room temperature and then kneaded until the consistency of the mixture is smooth and elastic. Three quarters of a cup of vegetable oil are gradually added to the imprint mixture during kneading. To knead is to mix and work into a uniform mass as by folding, pressing and stretching with the hands. The imprint mixture can be used immediately or refrigerated in an airtight container until needed. In an alternative embodiment, two to three pounds of Playdoh® may be used as the imprint mixture 102.

The imprint mixture is then kneaded to the appropriate consistency 104. The kneaded imprint mixture 104 is then placed on a metallic sheet 106 such as a sheet of aluminum foil on a cookie sheet having a rim and a handle. The imprint mixture 104 is then sprayed with a non-toxic lubricating substance 108. By way of example and not of limitation, the lubricating substance used is a vegetable oil, or other such oil. Alternatively, Pam® cooking spray may be used.

The imprint mixture 104 is then rolled, smoothed and leveled using a rolling pin 110 to one-half the height of the mold. During and after rolling the imprint mixture 104, more lubricating substance 108 may be sprayed onto the imprint mixture 104.

A first impression is produced by pressing a three-dimensional object 112 into the imprint mixture 104. By way of example and not of limitation, an appendage, such as a hand 112, is pressed into the imprint mixture 104 for one to two seconds to create an imprint 114, and then removed. To make imprint 114 of a hand, each finger is pressed into the imprint mixture, followed by the thumb, knuckles and the heel of the hand. The user observes the imprint 114 thus produced, and determines if it is acceptable according to personal taste. If the imprint 114 is not acceptable, the imprint mixture is again rolled to the appropriate smoothness and height. After a satisfactory larger imprint 114 is produced, a smaller hand 116 may be pressed into the first imprint 114 in the imprint mixture 104, creating a second imprint 118 within the first imprint 114.

A mold 120 having a geometric shape, e.g. circular, is then placed into the center of the imprint mixture 104 around the two imprints 114 and 118, with the edge of the mold placed directly into imprint mixture 104. By way of example and not of limitation, the illustrative mold 120 has a circular shape. Additionally, the mold may have a heart-shape or a quarter-moon shape or any other such geometric shape.

The mold 120 is pressed firmly into the imprint mixture 104 until the level line 122 of the mold is flush with the surface of the imprint mixture 104. A mark may be made at the top center of the mold to indicate where a hanger should be placed. A hanger 124 provides a means for suspending an object. A hanger 124 may be generated by bending half of a pipe cleaner into a U-shape. It should be appreciated by those of ordinary skill in the art that the use of a pipe cleaner as a hanger is provided as an illustrative example. Any other such U-shaped object with sufficient tensile strength may be used.

The illustrative molding compound is generated by mixing a molding compound combination comprising plaster of paris, a dry-mix filler such as Fix-All®, and water in the illustrative re-sealable container 126 until it is slightly thinner than pancake batter. By way of example and not of limitation the re-sealable container 126 is a Ziploc® bag or a cylindrical container. Plaster of paris is a calcium sulfate hemi-hydrate. Dry-mix fillers comprise calcium carbonate and calcium sulfate that are a soft powder which forms a smooth paste that dries quickly. Those skilled in the art shall appreciate that a variety of other molding compounds may be used. Thus, the materials described above are provided for illustrative purposes only.

The molding compound 130 is then poured into the imprint mixture 104 and mold 120. The molding compound 130, imprint mixture 104 and mold 120 are gently shaken 132 on a horizontal axis to level the molding compound 130 and release any air bubbles in the molding compound 130. The hanger 124 which was produced or provided is then embedded in the molding compound at the previously marked area.

Excess molding compound is removed from the imprint mixture, and the cast is allowed to partially cure 134 by being placed in a clean, non-humid area, and preferably in the sun, for half an hour. Any excess imprint mixture 104 on the exterior of the mold 120 is removed, and may be stored for later use. The mold is then separated from the molding compound 136 by placing pressure on the finger releases located on the interlocking sections of the mold 120. If the mold does not release, a utensil can be used to gently pry the sections apart. The resulting reverse imprint cast is cleaned with a damp paper towel, allowed to completely cure 138 for two to three days at room temperature, or four to six hours in a 200° degree oven. After being completely cooled the cast is cleaned of any excess imprint mixture and sanded 140. Any holes in the cast are filled with additional molding compound. If holes are filled, the cast is allowed to sit in a clean, non-humid area for an additional twenty-four hours, and the cast is sanded again until completely smooth. The cast is then lightly sprayed with a protective layer of rapid-drying paint 142. By way of example and not of limitation, a spray paint such as Krylon® paint may be used. The paint is allowed to dry, and the cast is decorated 150 with beads or other handicraft items according to the user's personal taste.

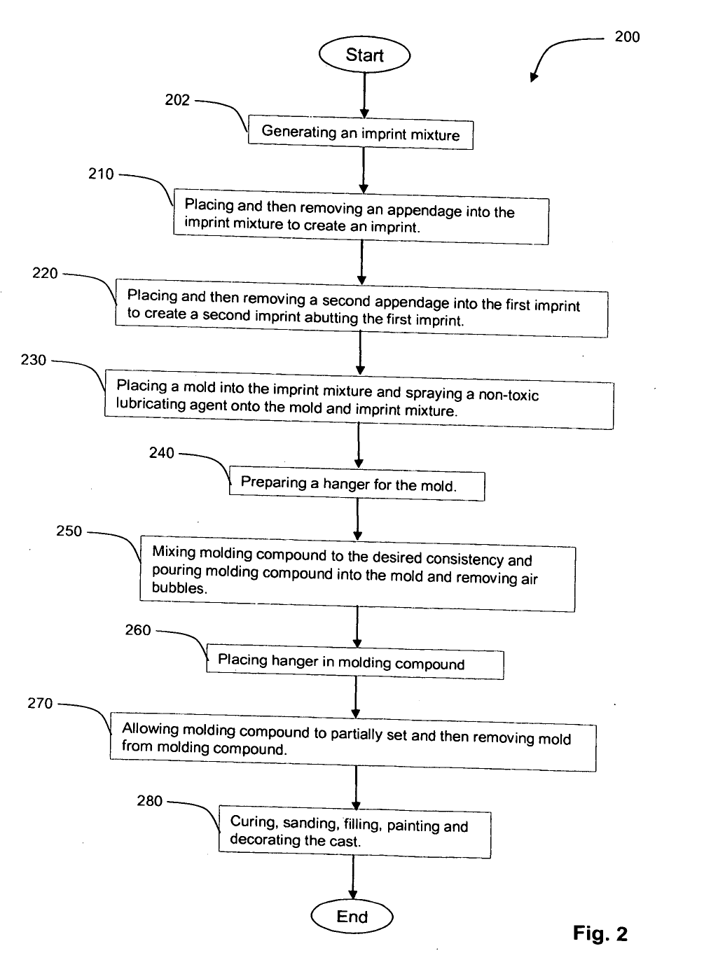

Referring to FIG. 2, there is shown a flowchart 200 of the method used to produce a reverse imprint cast. The method allows the user to create a plurality of imprint casts using the provided imprint mixture because the imprint mixture is inexpensive, reusable, and easily obtainable.

The user first generates an imprint mixture 202 using the formula described above, which is nontoxic and composed of relatively inexpensive common household materials. The imprint mixture is then kneaded as described above. The imprint mixture is then placed on a metallic sheet such as aluminum foil or a cookie sheet having a rim and a handle. The imprint mixture, foil, and cookie sheet are sprayed with a non-toxic lubricating substance. By way of example and not of limitation, the lubricating substance used is a cooking oil spray. The imprint mixture is rolled as smooth and level as possible using a rolling pin or a clean two-liter soda bottle, to one-half the height of the mold. During and after rolling the imprint mixture, more lubricating substance is sprayed onto the imprint mixture.

A first impression is produced by pressing an object into the imprint mixture 210. By way of example and not of limitation, a larger appendage, such as a hand may be the object that is pressed into the imprint mixture. However, any object of suitable size and shape can be used to make the impression. The object is pressed into the imprint mixture for one to two seconds to create an imprint, and then removed. To make an imprint of a hand, each finger is pressed into the imprint mixture compound, followed by the thumb, knuckles and the heel of the hand. The user observes the imprint thus produced, and determines if it is acceptable according to personal taste. If the imprint is not acceptable, the imprint mixture is again rolled to the appropriate smoothness and height.

After a satisfactory larger imprint is produced, a smaller object may be pressed into the first imprint in the imprint mixture, creating a second imprint within the first imprint 220. By way of example but not of limitation, a smaller appendage may be a child's hand or a pet's paw or any other such object or appendage. Any object of suitable size and shape can be used to make the second impression.

A mold having a geometric shape, such as a circle, is then placed into the center of the imprint mixture 230. By way of example and not or limitation, the mold is placed around the two imprints. The mold is pressed firmly into the imprint mixture until the level line of the mold directly abuts the top of the imprint mixture 230. A mark is made at the top center of the imprint mixture to indicate where a hanger should be placed. A hanger is a means of suspending an object. A hanger may be prepared by bending half of a pipe cleaner into a U-shape, and bending the legs of the “U” perpendicular to bend of the “U” 240. It should be appreciated that the use of a pipe cleaner as a hanger is provided as an example, and not a limitation. Any type of hanger of sufficient strength and shape can be used.

A molding compound is generated 250. The molding compound may be generated by mixing the provided mixture of equal parts plaster of paris and Fix-All® with water in the provided re-sealable container until it is slightly thinner than pancake batter. The molding compound is poured into the imprint mixture and mold and gently shaken on a horizontal axis to level the molding compound and release any air bubbles in the molding compound. The hanger which was produced or provided is then embedded in the molding compound at the previously marked area 260.

Excess molding compound is removed from the imprint mixture, and the cast is allowed to partially cure by being placed in a clean, non-humid area, and preferably in the sun, for half an hour 270. Any excess imprint mixture on the exterior of the mold is removed, and is stored for later use. The mold is then separated from the molding compound by placing pressure on the finger releases located on the interlocking sections of the mold 270. If the mold does not release, a utensil can be used to gently pry the sections apart. Because the interlocking tabs of the mold release without having to break the mold, the method which is described allows the user to generate a plurality of reverse imprint casts using the same mold.

The resulting imprint cast is cleaned with a damp paper towel, allowed to completely cure 280 for two to three days at room temperature, or four to six hours in a 200° oven. After being completely cooled the cast is cleaned of any excess imprint mixture and sanded. Any holes in the cast are filled with additional molding compound. If holes are filled, the cast is allowed to sit in a clean, non-humid area for an additional twenty-four hours, and the cast is sanded again until completely smooth. The cast is then lightly sprayed with a protective layer of rapid-drying paint. The paint is allowed to dry, and the cast is decorated with beads or other handicraft items according to the user's personal taste 280.

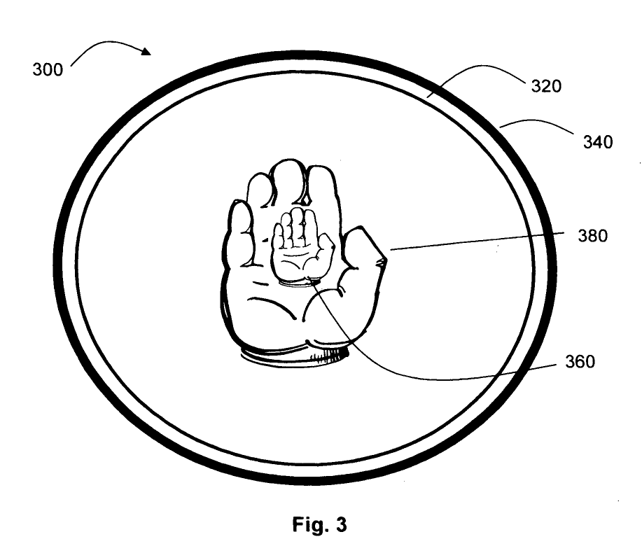

Referring to FIG. 3 there is shown a top view of a circular imprint cast inside of a mold 300. By way of example and not of limitation, the mold shown is a circular shape; however, the mold may have any geometric shape. In the figure, there is shown a circular mold 340 around a circular base 320. There is further shown a reverse imprint cast of a smaller hand 360 above and abutting a reverse imprint cast of a larger hand 380. The cast of the larger hand 380 is above and abutting the circular base 320.

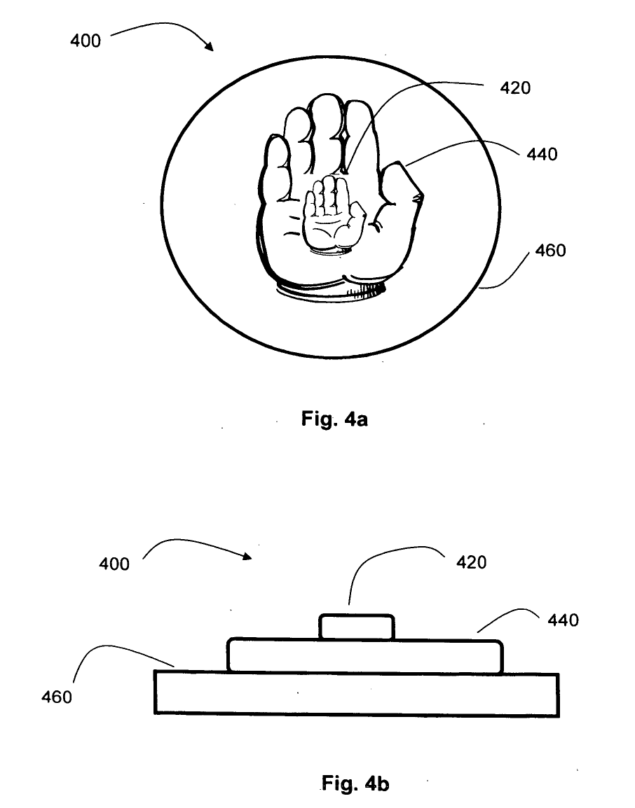

Referring to FIG. 4a, there is shown a top view of the resultant circular imprint cast 400 created by the method described above. In the illustrative embodiment, there is shown a reverse imprint cast of a smaller hand 420 above and abutting a cast of a larger hand 440. The larger hand is situated above and abutting a circular base 460.

Referring to FIG. 4b there is shown a side view of the illustrative circular imprint cast 400 created by the method described in this patent. There is shown a reverse imprint cast of a smaller hand 420 above and abutting a reverse imprint cast of a larger hand 440, which is above and abutting the illustrative circular base 460.

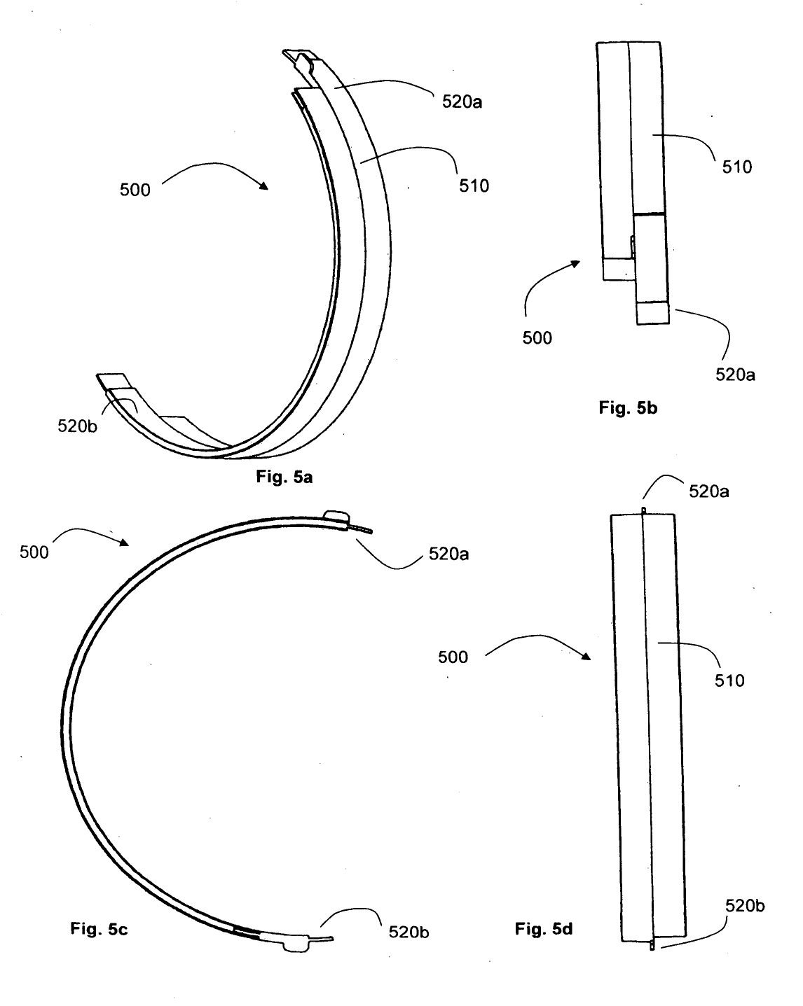

Referring to FIGS. 5a through 5d, there is shown various views of an interlocking first section of a circular mold 500 of the kit claimed in this patent. In FIG. 5a, there is shown an isometric view of the interlocking first section of the circular mold. The mold comprises a level line 510 which is configured to be used as a guide to determine the desired depth in which to insert the mold into the imprint mixture. The mold further comprises interlocking tabs of the first section 520a and 520b which are configured to interface with the interlocking tabs of the second section of the mold. The second section of the mold has the same shape as the first section of the mold. The tabs on the first section are configured to interface with the tabs in the second section and are further configured to be separated when slight pressure is applied.

In FIG. 5b, there is shown a side view of the interlocking first section of the circular mold 500, comprising interlocking tabs 520a and 520b (not shown), and further comprising a level line 510. In FIG. 5c, there is shown a top view of the interlocking first section of the circular mold 500, comprising the interlocking tabs 520a and 520b, and further comprising a level line 510 (not shown). In FIG. 5d, there is shown a front view of the interlocking first section of the circular mold 500, comprising the interlocking tabs 520a and 520b, and further comprising a level line 510.

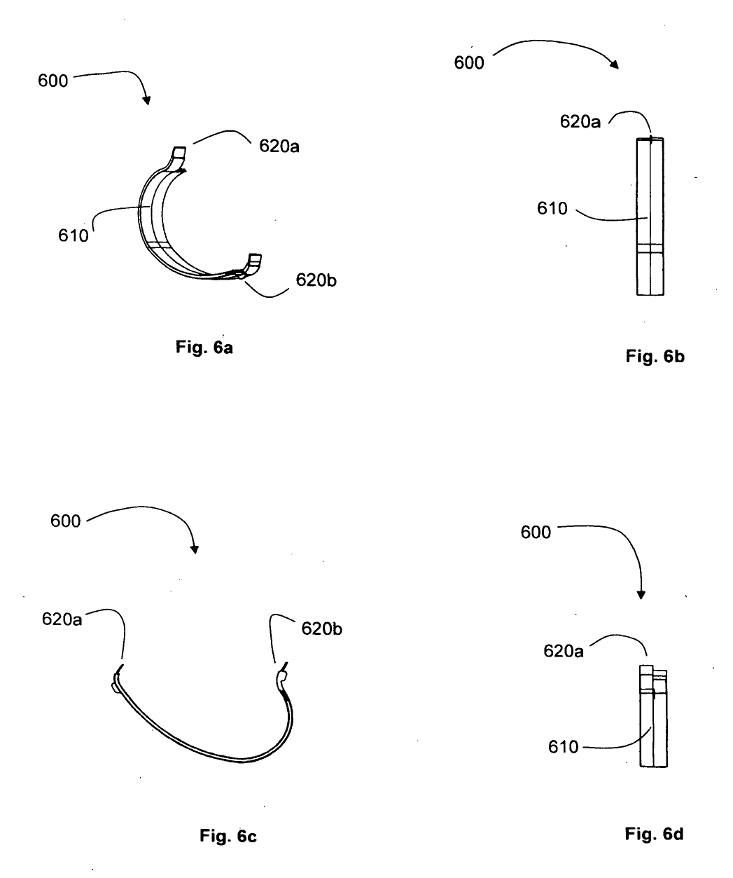

Referring to FIGS. 6a through 6d, there is shown various views of an interlocking first section of a heart-shaped mold 600 of the kit claimed in this patent. In FIG. 6a, there is shown an isometric view of the interlocking first section of the heart-shaped mold 600. The mold comprises a level line 610 which is configured to be used as a guide to determine the desired depth in which to insert the mold into the imprint mixture. The mold further comprises interlocking tabs of the first section 620a and 620b which are configured to interface with corresponding tabs on the second section of the mold, which is the same shape as the first section of the mold. The combination of the first section and the second section are configured to be releaseably coupled to one another. Thus, the first section and the second section are configured to be separated when slight pressure is applied to the tabs 620a and 620b.

In FIG. 6b, there is shown a front view of the interlocking first section of the heart-shaped mold 600 comprising interlocking tabs 620a and 620b, and further comprising a level line 610. In FIG. 6c, there is shown a top view of the interlocking first section of the heart-shaped mold 600, comprising interlocking tabs 620a and 620b, and further comprising a level line 610. In FIG. 6d, there is shown a side view of the interlocking first section of the heart-shaped mold 600 comprising the interlocking tabs 620a and 620b, and further comprising a level line 610.

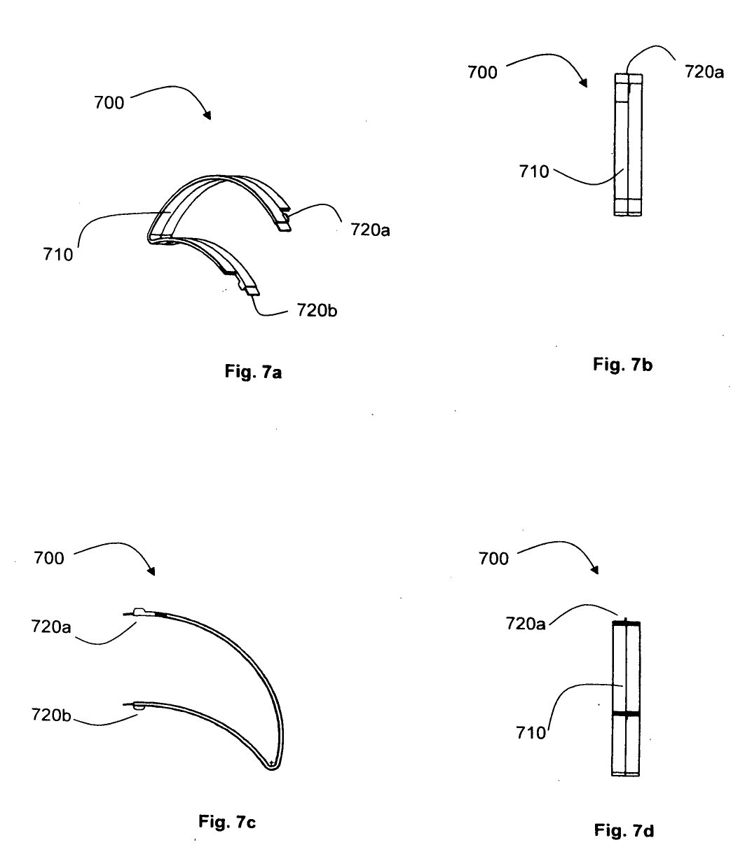

Referring to FIGS. 7a through 7d, there is shown various views of an interlocking first section of a quarter moon-shaped mold 700 of the kit claimed in this patent. In FIG. 7a, there is shown an isometric view of the interlocking first section of the quarter moon-shaped mold 700. The mold comprises a level line 710 which is configured to be used as a guide to determine the desired depth in which to insert the mold into the imprint mixture. The mold further comprises interlocking tabs of the first section 720a and 720b which are configured to interface with corresponding tabs on the second section of the mold. The second section of the mold is a duplicate of the first section of the mold. The first section is releaseably coupled to the second section and is further configured to be separated when slight pressure is applied to the tabs 720a and 720b and the corresponding tabs on the second section.

In FIG. 7b, there is shown a front view of the interlocking first section of the quarter moon-shaped mold 700 comprising interlocking tabs 720a and 720b, and further comprising a level line 710. In FIG. 7c, there is shown a top view of the interlocking first section of the quarter moon-shaped mold 700, comprising interlocking tabs 720a and 720b, and further comprising a level line 710. In FIG. 7d, there is shown a side view of the interlocking first section of the quarter moon-shaped mold 700 comprising the interlocking tabs 720a and 720b (not shown), and further comprising a level line 710.

It is to be understood that the foregoing is a detailed description of illustrative embodiments. The scope of the claims is not limited to these specific embodiments. Various elements, details, execution of any methods, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A reverse imprint casting kit, said kit comprising:
a mold having a geometric shape, said mold comprising a first section and a second section wherein each section has two interlocking tabs;
a formula for an imprint mixture, said imprint mixture being non-toxic and non-irritating;
a powdered molding compound; and
a container to receive said powdered molding compound and water.

2. The kit of claim 1 wherein the interlocking tabs of said first section and said second section are configured to interface with one another and further configured to be separated when slight pressure is applied to the interlocking tabs.

3. The kit of claim 2 wherein said mold further comprises a level line, said level line configured to be used as a guide to determine the desired depth in which to insert the mold into the imprint mixture.

4. The kit of claim 3 wherein said molding compound cures within 24 hours.

5. The kit of claim 3 wherein said mold is a circular shape.

6. The kit of claim 3 wherein said mold is a quarter moon shape.

7. The kit of claim 3 wherein said mold is a heart shape.

8. An apparatus for producing a reverse imprint cast, comprising:
a mold having a geometric shape, said mold comprising a first section and a second section that are interlocked;
an imprint mixture that is non-toxic and non-irritating, said imprint mixture shaped to receive said mold, said mold is placed into the imprint mixture up to a level line;
an imprint that is generated by pressing an object into the imprint mixture;
a powdered molding compound that is mixed with water inside a container, said molding compound is poured into said imprint mixture and said mold, and said molding compound is allowed to partially cure;
said imprint mixture is removed and said interlocking first section and second section are released; and
said molding compound permitted to completely cure, resulting in the reverse imprint cast.

9. The apparatus of claim 8 wherein the mold is reusable.

10. The apparatus of claim 8 wherein the interlocking first section and second section are disconnected by depressing tabs.

11. The apparatus of claim 8 wherein said mold has a geometric shape.

12. The apparatus of claim 11 wherein said geometric shape is a heart.

13. The apparatus of claim 11 wherein said geometric shape is a circle.

14. A method for producing a reverse imprint cast, comprising:
providing an imprint mixture;
shaping the imprint mixture to receive a mold;
pressing one or more objects into the imprint mixture;
placing the mold into the imprint mixture up to a level line;
mixing water with a powdered molding compound and pouring said molding compound into the imprint mixture and the mold;
allowing the molding compound to partially cure;
removing the mold and the imprint mixture; and
allowing the molding compound to fully cure resulting in the reverse imprint cast.

15. The method of claim 14 further, comprising:
providing a flexible material that is bent;
inserting said bent flexible material into the molding compound; and
using said bent flexible material as a hanger.

16. The method of claim 14 further comprising repeatedly generating a plurality of reverse imprint casts using the same mold.

17. The method of claim 14 further comprising repeatedly generating a plurality of reverse imprint casts using the same imprint mixture.

18. The method of claim 14 further comprising providing a means to rapidly cure said molding compound by baking using low heat.

19. The method of claim 14 wherein the mold has a geometric shape.

20. The method of claim 14 wherein the mold has a circular shape.
